(19) United States
(12) Patent Application Publication
(10) Pub. No.: US 2025/0194854 A1
(43) Pub. Date: Jun. 19, 2025

(54) MULTI-PURPOSE COOKWARE

(71) Applicant: Firebox Outdoors LLP, Moroni, UT (US)

(72) Inventor: Steven S. DeSpain, Moroni, UT (US)

(21) Appl. No.: 18/981,978

(22) Filed: Dec. 16, 2024

Related U.S. Application Data
(60) Provisional application No. 63/610,910, filed on Dec. 15, 2023.

(51) Int. Cl. A47J 37/06; A47J 36/02; A47J 37/10

(52) U.S. Cl. CPC A47J 37/067; A47J 36/025; A47J 37/10

(57) ABSTRACT

A cooking pan includes a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and four metal sidewalls extending away from the bottom wall and arranged in a substantially rectangular configuration to form a container closed on a first side by the bottom wall and open on second side opposite the bottom wall.

### CROSS-REFERENCE TO RELATED APPLICATION

This application claims priority to, and the benefit of, U.S. Provisional Patent Application. No. 63/610,910, filed Dec. 15, 2023, and entitled, FIREBOX FIVE-WAY, CAST-IRON COOKWARE,” which is incorporated herein by reference in its entirety for all purposes.

### TECHNICAL FIELD

This disclosure relates generally to cookware used with a stove and, in particular, to multi-purpose cookware used with a stove, for example, a portable stove.

### BACKGROUND

Portable stoves come in a variety of designs for different uses (e.g., camping, outdoor sporting events, picnicking, backpacking, or other use in remote locations where an easily transportable means of cooking or heating is needed). A common trait of portable stoves is they are often compact and lightweight, but these traits can sometimes cause the support for the stove to be unstable or insecure. Portable stoves also are used with cookware (e.g., pans and pots), and the cookware designed for use with portable stoves also is often compact and lightweight. Cookware designed for use with portable stoves often is intended for quickly heating liquids or for frying food, and cookware intended for baking (e.g., ovens) and grilling are not often designed for use with portable stoves. Therefore, a need exists both for stabilizing portable stoves when in use and for cookware that can be used with portable stoves for variety of cooking techniques, including frying, baking, and grilling.

### SUMMARY

In some aspects, the techniques described herein relate to an cooking pan including: a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and four metal sidewalls extending away from the bottom wall and arranged in a substantially rectangular configuration to form a container closed on a first side by the bottom wall and open on second side opposite the bottom wall.

In some aspects, the techniques described herein relate to a cooking pan, wherein the metal bottom wall further includes a raised rim that extends away from the lower surface around a perimeter of the bottom wall.

In some aspects, the techniques described herein relate to a cooking pan, wherein the raised rim includes a cutout section having height above the lower surface that is lower than other portions of the raised rim.

In some aspects, the techniques described herein relate to a cooking pan, wherein the plurality of raised ribs include a plurality of “L”-shaped ribs that extend inward from the raised rim and that are arranged to cooperate with one or more support structures of a portable stove to hold the portable stove in place.

In some aspects, the techniques described herein relate to a cooking pan, wherein the plurality of raised ribs include ribs having straight middle sections of various lengths and rounded end sections.

In some aspects, the techniques described herein relate to a cooking pan, wherein the plurality of raised ribs include ribs that from letters that spell one or more words.

In some aspects, the techniques described herein relate to a cooking pan, wherein the pattern of the plurality of raised ribs includes perpendicular lines devoid of ribs between pluralities of the raised rib, the perpendicular lines devoid of ribs being arranged to cooperate with one or more support structures of a portable stove to hold the portable stove in place.

In some aspects, the techniques described herein relate to a cooking pan, wherein the pattern of the plurality of raised ribs includes a rectangular path along the lower surface that surrounds a plurality of the raised ribs, wherein the path is devoid of any raised ribs and is configured to cooperate with one or more support structures of a portable stove to hold the portable stove in place.

In some aspects, the techniques described herein relate to a cooking pan, wherein a first sidewall of the four metal sidewalls includes a first flange extending outwardly away from the first sidewall and away from the container, wherein a second sidewall of the four metal sidewalls, which is opposite to the first sidewall, includes a second flange extending outwardly away from the sidewall and away from the container.

In some aspects, the techniques described herein relate to a cooking pan, wherein each of the first flange and the second flange include a surface having a raised nub that extends away from the surface and an indented divot that extends into the flange, a location and a size of the raised nub being configured for the raised nub, when the cooking pan is in an upright position, to fit into a corresponding indented divot on a flange of another cooking pan, and the location and the size of the indented divot being configured for the indented divot, when the cooking pan is in the upright position, to receive a corresponding indented divot on a flange of another cooking pan, when the other cooking pan is placed on the cooking pan in an inverted position to form an internal cavity that includes the container of the cooking pan and a container of the other cooking pan.

In some aspects, the techniques described herein relate to an apparatus including: a first cooking pan including: a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and four metal sidewalls extending away from the bottom wall and arranged in a substantially rectangular configuration to form a container closed on a first side by the bottom wall and open on second side opposite the bottom wall, the container having a first depth; and a second cooking pan including: a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and four metal sidewalls extending away from the bottom wall and arranged in a substantially rectangular configuration to form a container closed on a first side by the bottom wall and open on second side opposite the bottom wall, the container having a second depth.

In some aspects, the techniques described herein relate to an apparatus, wherein the second depth is different from the first depth.

In some aspects, the techniques described herein relate to an apparatus, wherein a first sidewall of the four metal sidewalls of the first cooking pan includes a first flange extending outwardly away from the first sidewall and away from the container, wherein a second sidewall of the four metal sidewalls of the first cooking pan, which is opposite to the first sidewall, includes a second flange extending outwardly away from the sidewall and away from the container, wherein each of the first flange and the second flange of the first cooking pan and of the second cooking pan include a surface having a raised nub that extends away from the surface and an indented divot that extends into the flange, a location and a size of the raised nubs of the first cooking pan being configured for the raised nubs, when the first cooking pan is in an upright position, to fit into corresponding indented divots second cooking pan, and the location and the size of the indented divots on the flanges of the first cooking pan being configured for the indented divots, when the first cooking pan is in the upright position, to receive corresponding indented divots of the second cooking pan, when the second cooking pan is placed on the first cooking pan in an inverted position to form an internal cavity that includes the container of the first cooking pan and the container of the second cooking pan.

In some aspects, the techniques described herein relate to an apparatus, further including a metal basket having four sidewalls and one bottom wall, dimensions the sidewalls and the bottom wall are complementary to interior dimensions of the container of the first cooking pan, such that the basket fits into the container, wherein the four sidewalls and the one bottom wall include patterns of openings that permit liquid and solid material having characteristic sizes smaller than the size of the openings to pass out of the basket.

In some aspects, the techniques described herein relate to an apparatus, wherein the metal bottom of each of the first and second cooking pans includes a raised rim that extends away from the lower surface around a perimeter of the bottom wall of the respective cooking pan.

In some aspects, the techniques described herein relate to an apparatus, wherein each raised rim includes a cutout section having height above the lower surface that is lower than other portions of the raised rim.

In some aspects, the techniques described herein relate to an apparatus, wherein the plurality of raised ribs of each of the first and second cooking pans include a plurality of “L”-shaped ribs that extend inward from the raised rim and that are arranged to cooperate with one or more support structures of a portable stove to hold the portable stove in place.

In some aspects, the techniques described herein relate to an apparatus, wherein the plurality of raised ribs of each of the first and second cooking pans include ribs having straight middle sections of various lengths and rounded end sections.

In some aspects, the techniques described herein relate to an apparatus, wherein the pattern of the plurality of raised ribs of each of the first and second cooking pans includes perpendicular lines devoid of ribs between pluralities of the raised rib, the perpendicular lines devoid of ribs being arranged to cooperate with one or more support structures of a portable stove to hold the portable stove in place.

In some aspects, the techniques described herein relate to an apparatus, wherein the pattern of the plurality of raised ribs of each of the first and second cooking pans includes a rectangular path along the lower surface that surrounds a plurality of the raised ribs, wherein the path is devoid of any raised ribs and is configured to cooperate with one or more support structures of a portable stove to hold the portable stove in place.

In some aspects, the techniques described herein relate to an apparatus, that includes a handle having a flat middle section, a flat first end, the middle section and the first end being in a common first plane, and a second end, the second end including a flat second end section and a curved section connecting the flat second end section to the flat middle section and the flat second end section being in a second plane that is non-parallel to the common first plane, and the flat second end including a plurality of protrusions being shaped and spaced from apart from each other such that each of the protrusions fits between a pair of adjacent raised ribs of the raised ribs.

### BRIEF DESCRIPTION OF THE DRAWINGS

The details of one or more implementations are set forth in the accompanying drawings and the in the detailed description below. Other features will be apparent from the description and the drawings, and from the claims.

FIG. 1 is a perspective view of a shallow multifunction pan.

FIG. 2 is a bottom view of the shallow multifunction pan.

FIG. 3 is a top view of the shallow multifunction pan.

FIG. 4 is a detailed perspective view of a corner portion of the shallow multifunction pan.

FIG. 5 is a side view of the shallow multifunction pan.

FIG. 6 is a perspective view of the shallow multifunction pan.

FIG. 7 is a bottom view of the deep multifunction pan.

FIG. 8 is a top view of the deep multifunction pan.

FIG. 9 is a detailed perspective view of a corner portion of the deep multifunction pan.

FIG. 10 is a side view of the deep multifunction pan.

FIG. 11 is a schematic perspective view of a portable stove and a shallow multifunction pan.

FIG. 12 is a photograph of an example portable stove connected to a shallow multifunction pan by support structures of the portable stove that fit into openings on a bottom wall of the pan between raised ribs on the bottom wall.

FIG. 13 is a photograph of another example portable stove connected to the shallow multifunction pan.

FIG. 14 is a photograph of another example portable stove connected to the shallow multifunction pan.

FIG. 15 is a photograph of a portable stove supported on a first shallow multifunction pan and a second shallow multifunction pan supported on top of a stove in a configuration in which a combustion chamber of the portable stove can heat the second shallow multifunction pan.

FIG. 16 is a photograph of an example upright shallow multifunction pan coupled to an inverted shallow multifunction pan by cooperating nubs and divots formed in the flanges of the two pans to form an internal cavity between the pans, which can be used as an oven for preparing food.

FIG. 17 is a photograph of an example inverted shallow multifunction pan resting on, and coupled to, a top of a portable stove.

FIG. 18 is a photograph of an example inverted shallow multifunction pan resting on, and coupled to, a top of a portable stove, with the inverted deep multifunction pan resting on, and coupled to, the inverted shallow multifunction pan.

FIG. 19 is a schematic bottom perspective view of a basket that can be used with a deep multifunction pan or a shallow multifunction pan.

FIG. 20A is a perspective view from a top side of an example handle, according to an implementation.

FIG. 20B is a perspective view from a bottom side of the example handle of FIG. 20A.

FIG. 20C is a top view of the example handle of FIG. 20A.

FIG. 20D is a bottom view of the example handle of FIG. 20A.

FIG. 20E is a side view of the example handle of FIG. 20A.

FIG. 20F is an enlarged view of a first portion of the example handle shown in the circle “A” of FIG. 20E.

FIG. 20G is an enlarged view of a second portion of the example handle shown in the circle “B” of FIG. 20E.

FIG. 21 is a schematic diagram showing handles coupled to pans in downward and upward facing orientations.

Like reference symbols in the various drawings indicate like elements.

### DETAILED DESCRIPTION

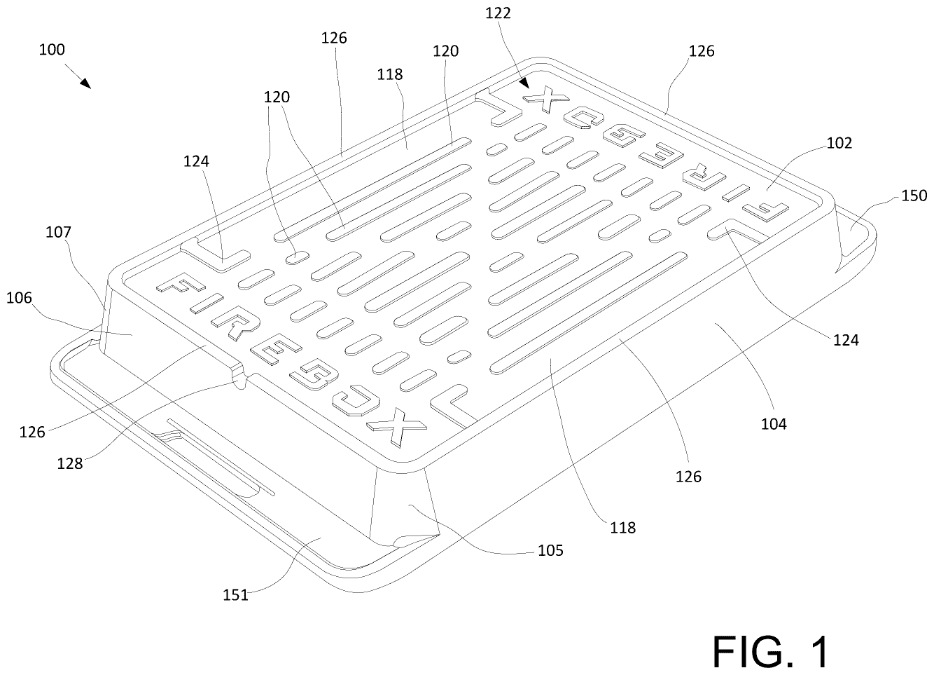

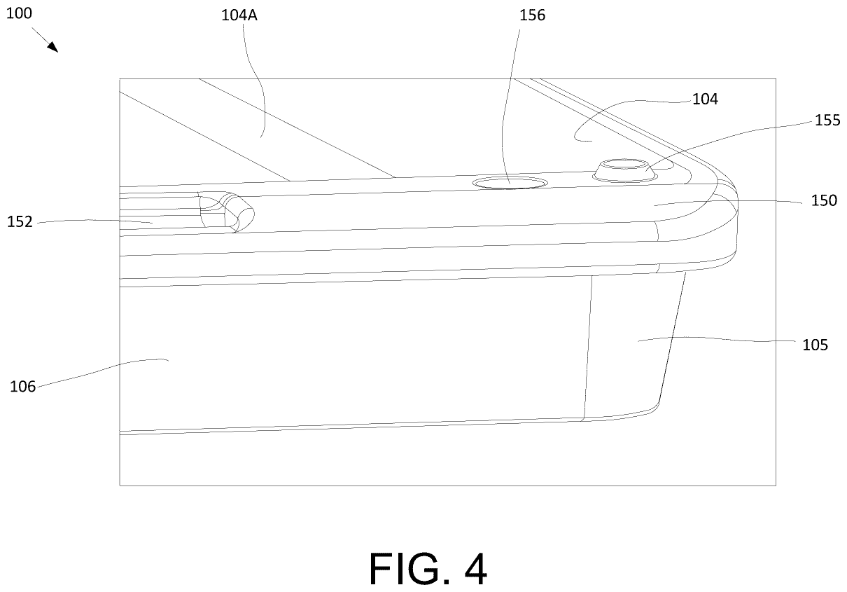

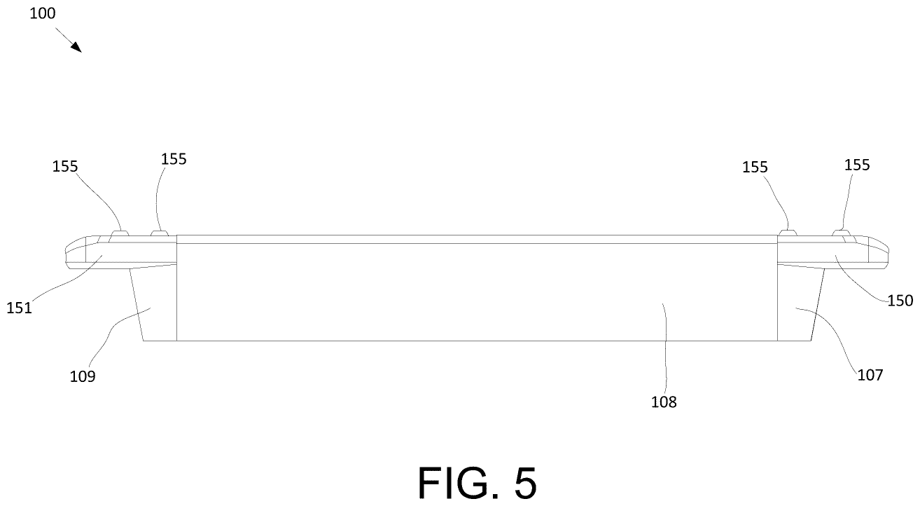

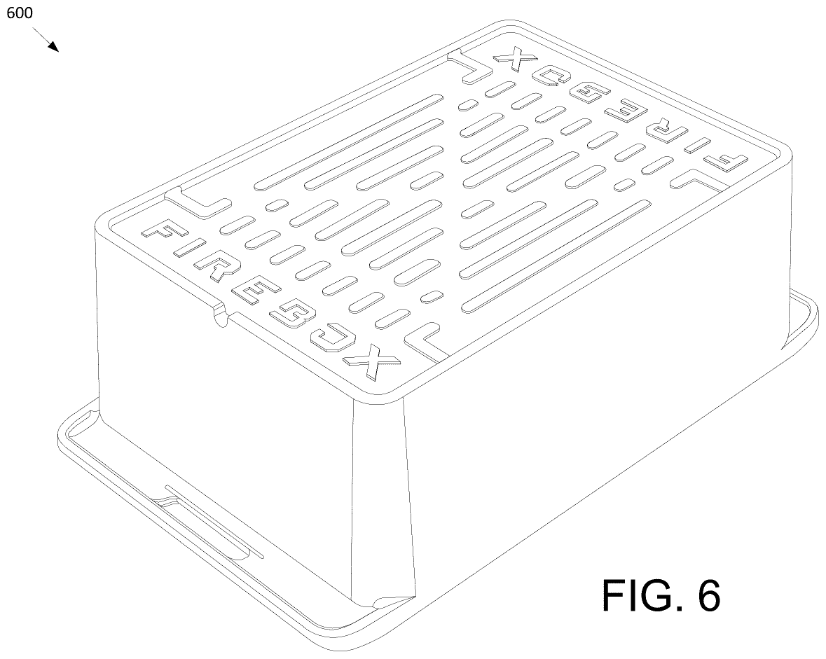

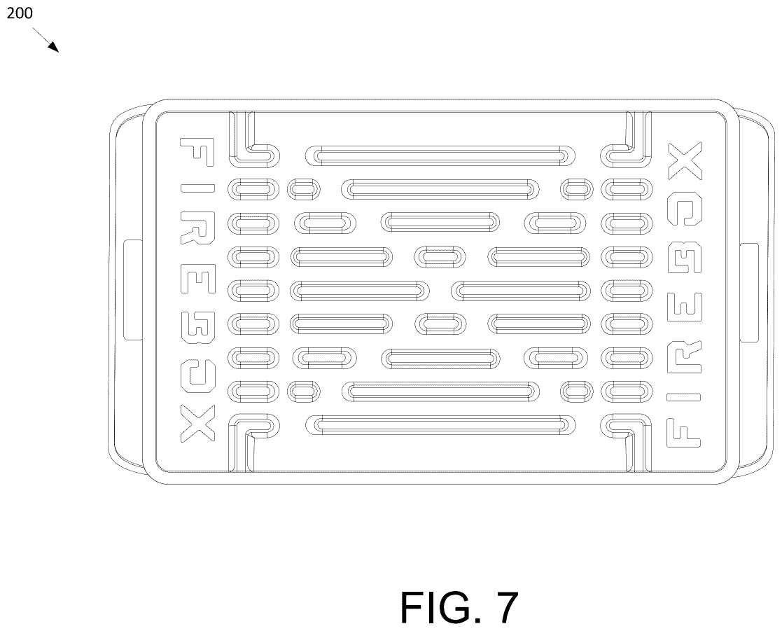

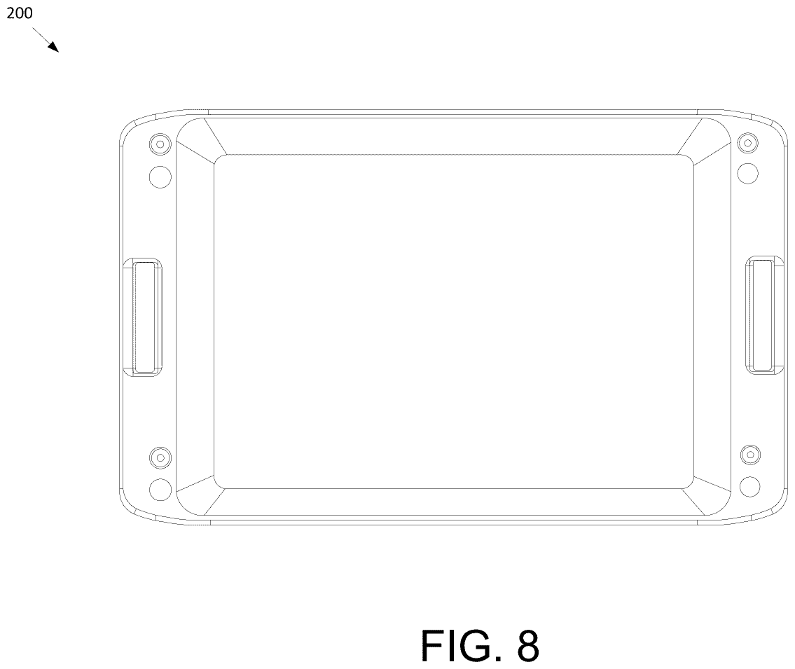

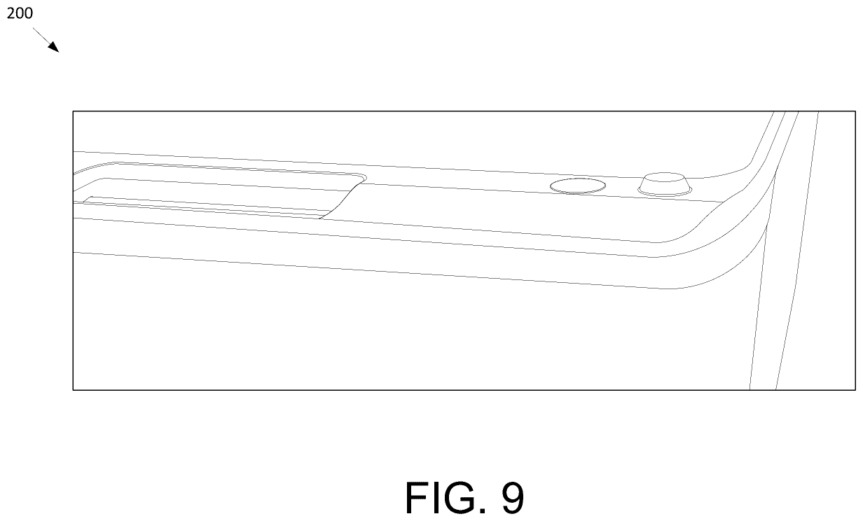

FIGS. 1-5 are different views of a shallow multifunction pan 100 that can be used for stabilizing portable stoves when the stove is in use and for frying, baking, and grilling food with heat provided from a portable stove. FIGS. 6-10 are different views of a deep multifunction pan 200 that can used for stabilizing portable stoves when the stove is in use and for frying, baking, and grilling food with heat provided from a portable stove. FIG. 6 is a perspective view of the multifunction pan 100. FIG. 7 is a bottom view of the deep multifunction pan 200. FIG. 8 is a top view of the deep multifunction pan 200. FIG. 9 is a detailed perspective view of a corner portion of the deep multifunction pan 200. FIG. 10 is a side view of the deep multifunction pan 200.

Referring to FIGS. 1-5, the shallow multifunction pan 100, in some implementations, can include a bottom wall 102 and four sidewalls 104, 106, 108, 110 extending away from the bottom wall 102. In some implementations, the bottom wall 102 can have an approximately rectangular shape, and the sidewalls 104, 106, 108, 110 can form an approximately rectangular perimeter wall that extends upwards from the bottom wall 102. In some implementations, the lengths of opposite walls 104 and 108 can be approximately equal, and the lengths of opposite walls 106, 110 can be approximately equal. In some implementations, the lengths of sidewalls 104, 106 can be between 5 inches and 13 inches and the lengths of sidewalls 106, 110 can be between 3.5 inches and 9 inches. In some implementations, a ratio between the lengths of the longer sidewalls 104, 108 and the shorter sidewalls 106, 110 can be between 0.6 and 1.0. In some implementations, the height of the sidewalls 104, 106, 108, 110 above the bottom wall 102 can be between 0.6 inches and 1.2 inches.

In some implementations, adjacent sidewalls 104, 106, 108, 110 can be connected by curved corner sidewalls 105, 107, 109, 111. In some implementations, the curved corner sidewalls 105, 107, 109, 111 can have radii of curvature between about 0.5 inches and 3.0 inches.

Sidewalls 104, 105, 106, 107, 108, 109, 110, 111 can extend away from the bottom wall 102 in planes that are non-perpendicular to the plane of the bottom wall 102. For example, in some implementations, a plane of each sidewall 104, 106, 108, 110 can tilt outward, away from the center of the bottom wall 102, as the sidewall extends away from the bottom wall. In other words, a bottom portion of each sidewall 104, 106, 108, 110, which is proximate to the bottom wall 102, can be closer to its opposite sidewall than a top portion of the sidewall, which is distal to the bottom wall 102, is to its opposite sidewall.

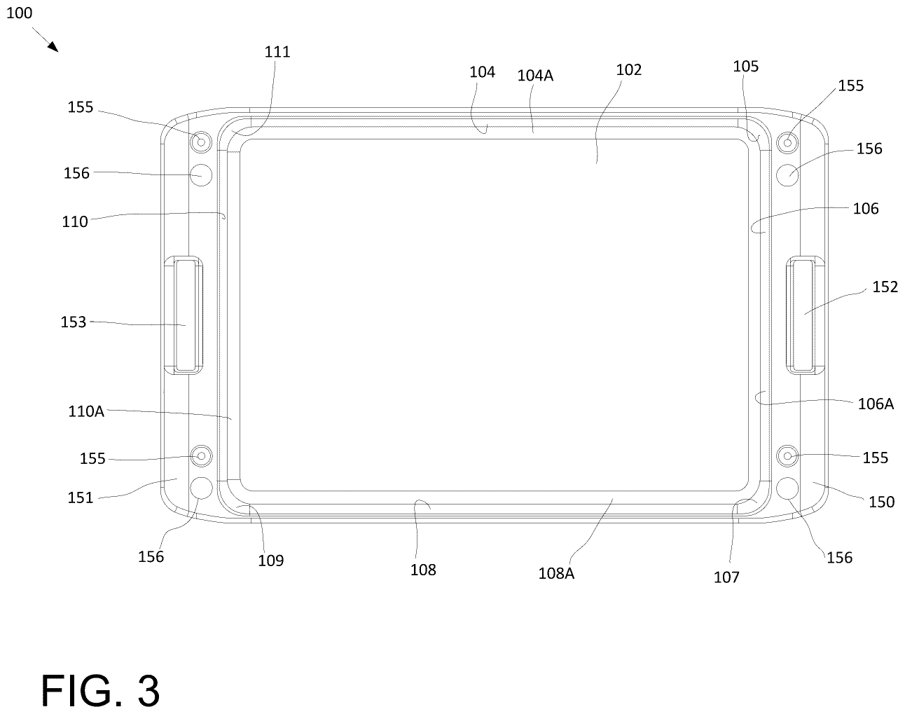

Referring in particular to FIG. 3, in some implementations, the joints between sidewalls 104, 106, 108, 110 and bottom wall 102 may include concave fillets 104A, 106A, 108A, 110A, so as to avoid sharp corners formed from the intersection of two planes. Thus, the connected bottom wall 102 and sidewalls 104, 106, 108, 110 can define a generally rectangular cooking container that is open on one side and closed on an opposite side. The bottom wall 102 and sidewalls 104, 106, 108, 110 can be made of metal, for example, cast iron or aluminum or copper. In some implementations, the thickness of the bottom wall 102 and sidewalls 104, 106, 108, 110 can be between about 0.125 inches and 0.375 inches. In some implementations, the thickness of the bottom wall 102 can be different (e.g., thicker) than the thickness of the sidewalls 104, 106, 108, 110. In some implementations, inside surfaces of the sidewalls 104, 106, 108, 110, the bottom wall 102 can be substantially flat. In some implementations, inside surfaces of the sidewalls 104, 106, 108, 110, the bottom wall 102, and the curved corner sidewalls 105, 107, 109, 111 that defined the generally rectangular cooking container can be substantially smooth. In some implementations, inside surfaces of the sidewalls 104, 106, 108, 110, the bottom wall 102, and the curved corner sidewalls 105, 107, 109, 111 can include surface coatings, such as, for example, enamel, or a non-stick coating (e.g., Polytetrafluoroethylene (PTFE)). The sidewalls 104, 106, 108, 110, and the bottom wall 102 can be heated, for example, by a portable stove, so that the sidewalls and bottom wall can transfer heat to food or other objects placed in, on, or near the multifunction pan 100.

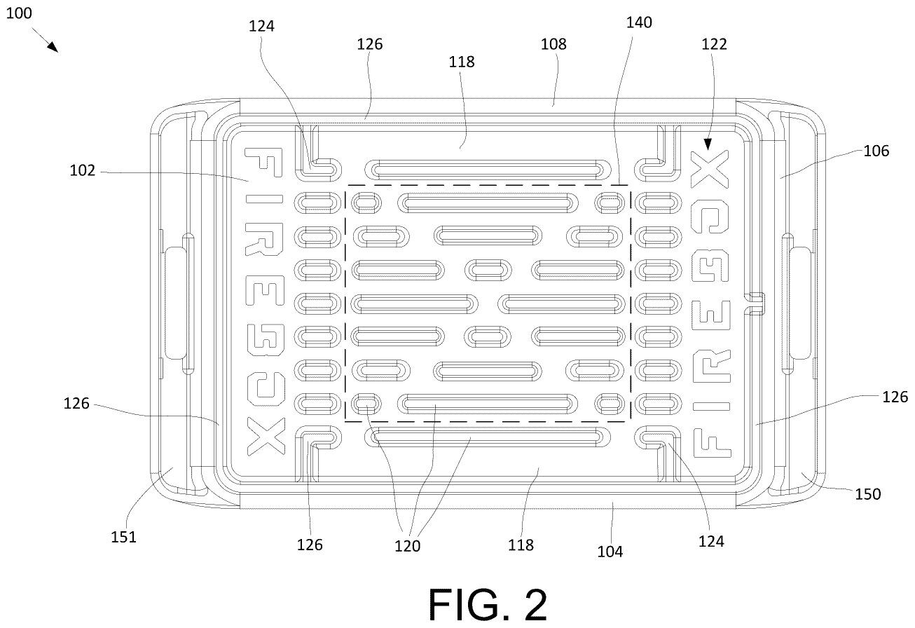

Referring now to FIG. 1 and FIG. 2, an outside surface of the bottom wall 102, can include a plurality of raised ribs 120 that extend away from a lower surface 118 of an outside of the bottom wall 102. In some implementations, the raised ribs 120 can extend away from the lower surface 118 by between 0.1 and 0.75 inches. In some implementations, the raised ribs 120 can extend between 0.125 inches and 0.5 inches above the lower surface 118 of the bottom wall 102. As shown in FIGS. 1-2, the raised ribs 120 can be oblong in shape, having rounded ends and straight middles sections, where the middle sections have various lengths. The rounded ends can have identical radii of curvature, or, in some implementations, the radii of curvature can be different for different ribs. In some implementations, the raised ribs can include ribs arranged in the shapes of one or more numbers or letters 122, for example, letters that spell a word associated with a manufacturer or seller of the multifunction pan 100. In some implementations, the raised ribs can include shapes other than oblong shapes, numbers or letters. For example, the raised ribs can include one or more “L”-shaped ribs 124. When the multifunction pan 100 is heated, the plurality of raised ribs 120 can be used to grill or sear food. For example, the multifunction pan 100 can be heated with the ribbed surface of the bottom wall 102 facing up (relative to the direction of gravity) and food (e.g., meat) can be placed on the surface to be cooked. The presence of the ribs 120 on the exterior surface of the bottom wall 102 permits the food to be grilled without bathing in fats and oils that are secreted from the food when the food cooks.

In some implementations, the exterior surface of the bottom wall 102 can include a raised rim 126 that extends away from the lower surface 118 around a perimeter of the bottom wall and that surrounds a plurality of the raised ribs. In some implementations, the raised rim 126 can extend between 0.125 inches and 0.5 inches above the lower surface 118 of the bottom wall 102. The raised rim can serve to contain fats, oils, and other food products on the lower surface 118 or on the raised ribs 120 within the confines of the raised rim. In some implementations, the raised rim 126 can include a cutout 128, where the height of the rim is lower than at other portions of the rim, so that grease, water, and other liquids can be easily drained from the lower surface 118 of the bottom wall 102.

In addition to being used for grilling meat, the raised ribs 120 can be used to bake waffles. For example, two multifunction pans 100 can be heated, waffle batter can be placed on a ribbed surface of one of the pans, and the heated ribbed surface of the other pan can be placed on top of the first pan, with the batter being between the two pans, so that the batter can bake between the two pans. In some cases, while the batter is baking, the bottom pan can be heated from the bottom by a portable stove, and the top pan can be heated from the top by heat from burning fuel (e.g., burning wood, coals, etc. placed on top of the top pan. In some implementations, the pattern of the plurality of raised ribs 120 on the pans 100 can be arranged, such that when the ribbed exterior surfaces of two pans are placed face to face with their rims aligned, the ribs of one pan are not aligned with ribs of the other pan, but rather are aligned with portions of the lower surface 118 of the other pan.

The pattern in which the plurality of raised ribs 120 is arranged on the bottom wall 102 can be selected, such that the ribs can cooperate with supports of a portable stove to securely hold the portable stove in place. FIG. 11 is a schematic perspective view of a portable stove 1100 and the shallow multifunction pan 100. The portable stove 1100 can include a combustion chamber 1101 in which wood and other fuels found in nature, solid fuel tablets, alcohol burners, iso-butane gas burners, gel fuels (Sterno), wood pellets, charcoal briquettes, and other fuels can be combusted. The combustion chamber 1101 can be supported by a plurality of support structures 1102 that support the combustion chamber above the support structures. In some implementations, the support structures 1102 can include metal rods that extend away from the corners of the combustion chamber 1101. In some implementations, when for support structures 1102 are used, the support structures 1102 can be arranged in a plane, and each support structure can be oriented at a 90° angle relative to the two nearest other support structures. The pattern in which the plurality of raised ribs 120 is arranged on the bottom wall 102 of the pan 100 can include lines 130, 131 along the lower surface that are devoid of any raised ribs 120 and that can cooperate with the support structures 1102 of the portable stove 1100 to securely hold the portable stove in place.

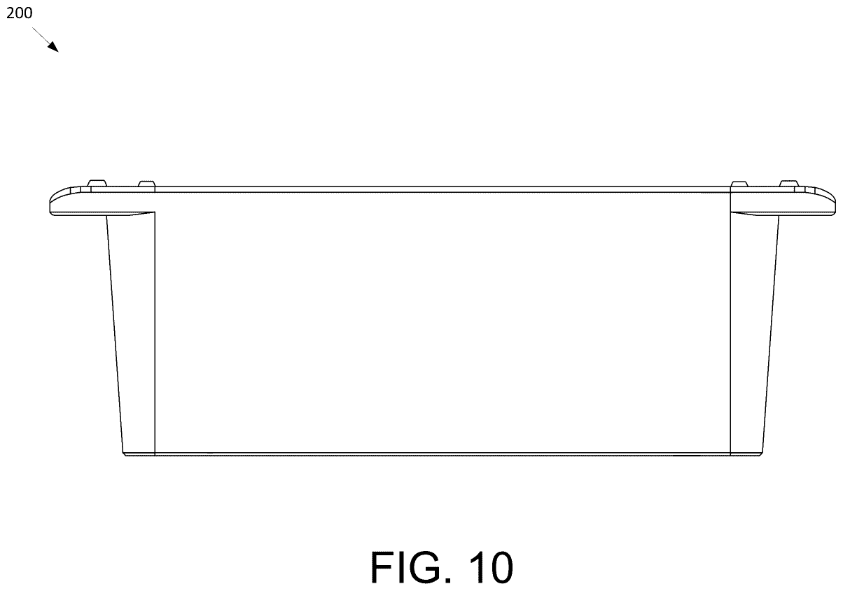

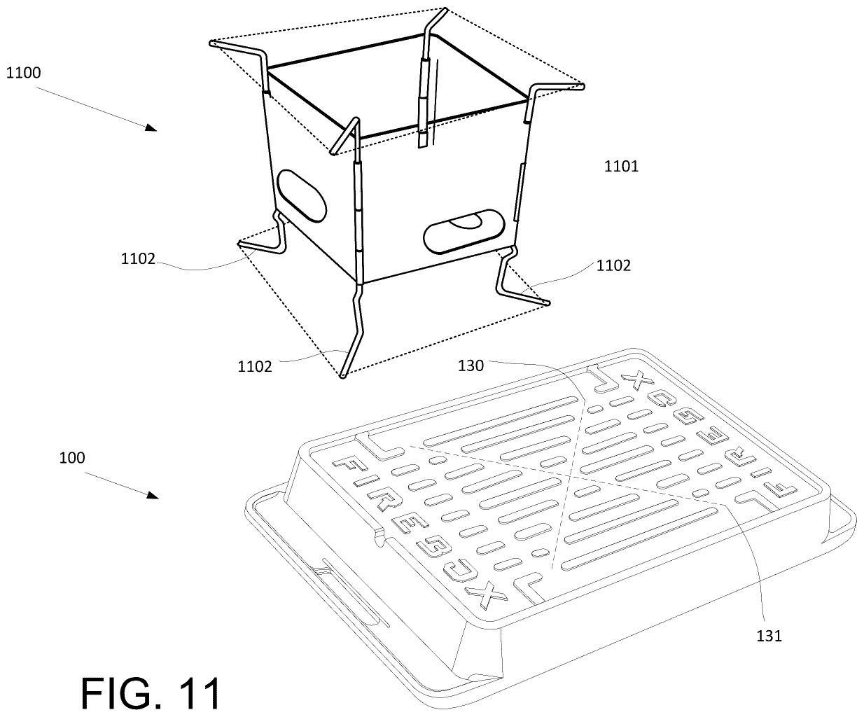

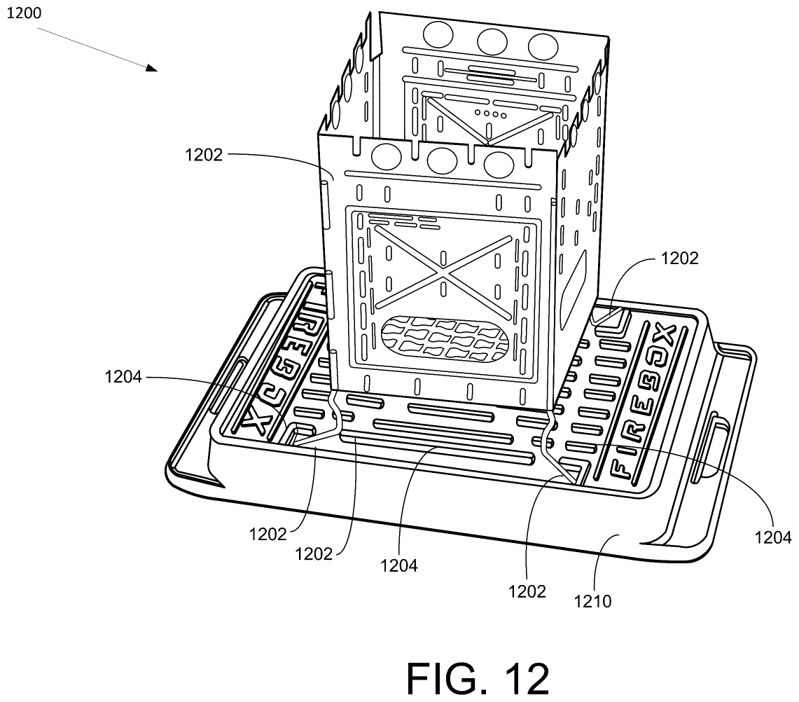

FIG. 12 is a photograph of an example portable stove 1200 connected to a shallow multifunction pan 1210 by support structures 1202 of the portable stove that fit into openings on a bottom wall of the pan between raised ribs 1204 on the bottom wall.

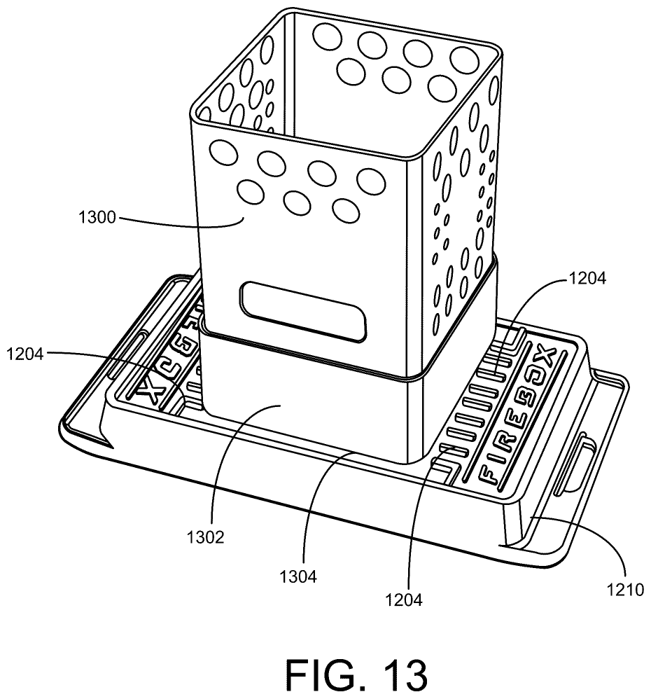

FIG. 13 is a photograph of another example portable stove 1300 connected to the shallow multifunction pan 1210. The portable stove 1300 can include a lower support structure 1302 that includes a bottom perimeter rim 1304 that is approximately square. Referring again to FIG. 2, the pattern in which the plurality of raised ribs 120 is arranged on the bottom wall 102 of the pan 100 can include a rectangular or square path 140 along the lower surface 118 that is devoid of any raised ribs 120 and that can cooperate with one or more support structures of a portable stove to securely hold the portable stove in place. Referring again to FIG. 13, the bottom perimeter rim 1304 can be approximately rectangular or square, such that it fits into a rectangular or square path between raised ribs 1204 on the bottom wall of the shallow multifunction pan 1210.

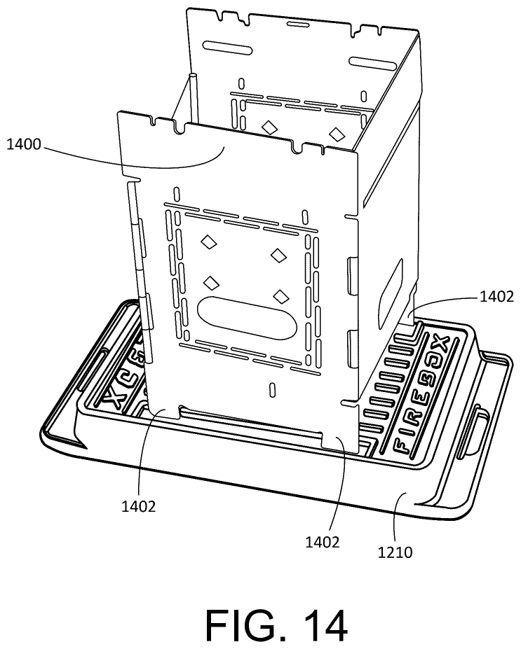

FIG. 14 is a photograph of another example portable stove 1400 connected to the shallow multifunction pan 1210. The portable stove 1300 can include support structures 1402 that include legs or feet that raise a combustion chamber of the stove 1400 above the support structures. Referring again to FIG. 2, the pattern in which the plurality of raised ribs 120 is arranged on the bottom wall 102 of the pan 100 can include “L”-shaped ribs 124 that extend inward from the raised rim 126 around the perimeter of the bottom wall 102 of the pan 100, and the “L”-shaped ribs 124 can cooperate with one or more support structures of a portable stove to securely hold the portable stove in place. Referring again to FIG. 14, the stove 1400 can have four support structures 1402 that can be approximately square or rectangular and that fit into openings on the bottom wall of the shallow multifunction pan 1210 between “L”-shaped ribs on the bottom wall and a raised perimeter rim on the bottom wall.

Thus, referring again to FIG. 1 and FIG. 2, the pattern in which the plurality of raised ribs 120 is arranged on the bottom wall 102 of the shallow multifunction pan 100 can cooperate with supports of a number of different portable stoves to securely hold the portable stoves in place on the shallow multifunction pan. In this manner, the pan 100 can function as a pedestal to raise the portable stoves above a surface on which the pan rests. The surface on which the pan rests may be flammable or easily damaged by heat from the portable stove, and by using the pan as a pedestal to raise the portable stove above the surface, the portable stove may be sufficiently thermally insulated from the surface to protect the surface from damage.

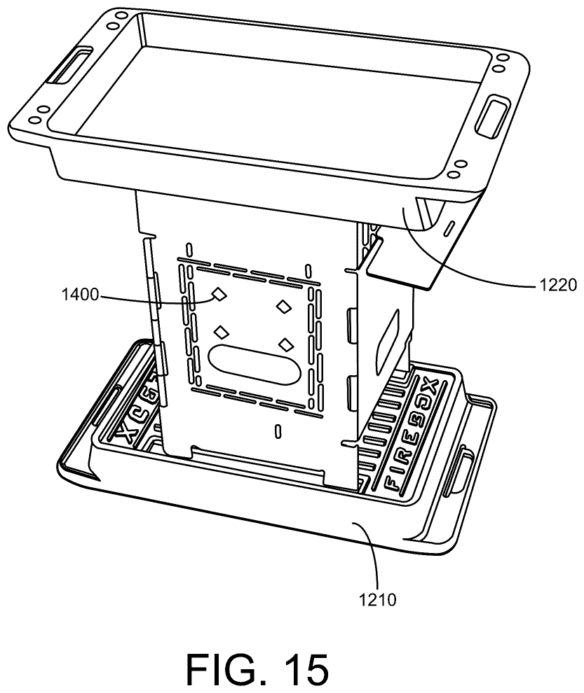

FIG. 15 is a photograph of a portable stove 1400 supported on a first shallow multifunction pan 1210 and a second shallow multifunction pan 1220 supported on top of the stove 1400 in a configuration in which the combustion chamber of the portable stove can heat the second shallow multifunction pan 1220. The pattern of ribs on the bottom wall of the second multifunction pan 1220 can cooperate with a top structure of the portable stove 1400 to hold the multifunction pan 1220 securely in place when it is supported by the portable stove 1400. For example, the top structure can have two opposing walls that fit into openings between raised ribs on the bottom wall of the shallow multifunction pan 1220. For example, one wall can fit between two “L”-shaped ribs located on one side of the bottom wall and between the two “L”-shaped ribs and a raised perimeter rim on the same side of the bottom wall, and the second wall can fit between two “L”-shaped ribs located on an opposite side of the bottom wall and between the two “L”-shaped ribs and a raised perimeter rim on the opposite side of the bottom wall.

Referring again to FIGS. 1-5, the shallow multifunction pan 100 can include flanges 150, 151 that extend away from tops of opposite sidewalls 106, 110, respectively. The flanges 150, 151 can include openings 152, 153, respectively, that can serve as handles to grasp the pan 100. In some implementations, the flanges can extend between about 0.5 inches and 1.5 inches away from the sidewalls.

Ends of each flange 150, 151 can include a raised nub 155 that extends away from a surface of the flange and an indented divot 156 that extends into the flange. The nubs 155 and the divots can be located on the flanges, so that nubs 155 of a first pan can fit into divots 156 of an inverted pan located on top of the first pan, and divots 156 of the first pan can receive nubs 155 of the inverted pan located on top of the first pan. In this manner, the inverted pan can be coupled to the first pan in an arrangement in which the nubs and divots of the two pans cooperate to hold the two pans together to form an enclosed cavity defined by the five-sided cooking containers of each of the pans. The enclosed cavity can be used as an oven to cook food within the cavity when heat is applied to the pans.

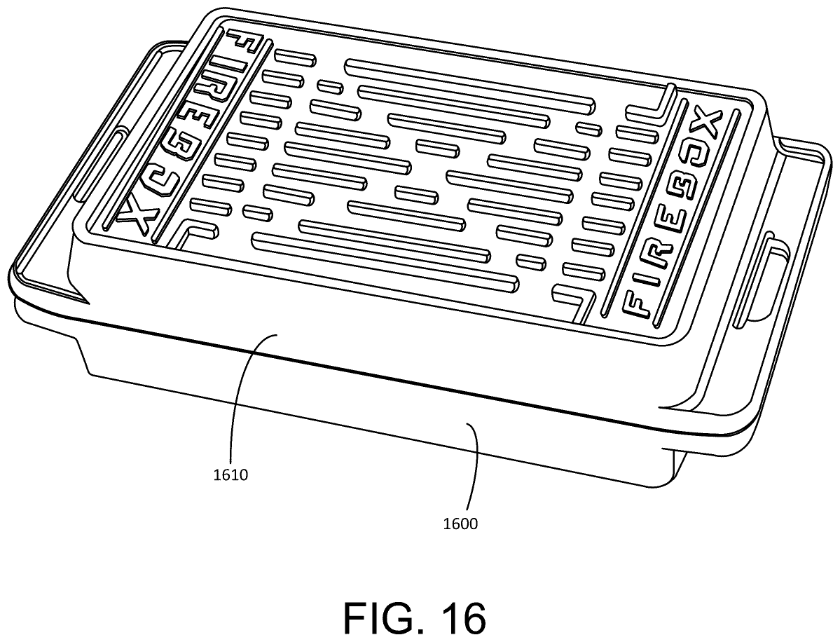

FIG. 16 is a photograph of an example upright shallow multifunction pan 1600 coupled to an inverted shallow multifunction pan 1610 by cooperating nubs and divots formed in the flanges of the two pans 1600, 1610 to form an internal cavity between the pans, which can be used as an oven for preparing food.

The deep multifunction pan 200 of FIGS. 6-10 is similar to the shallow multifunction pan 100 FIGS. 1-5, in that the deep pan 200 can have identical or similar features to those found in the shallow pan 100, and the deep pan 200 can be constructed at the same material as the shallow pan 100. The dimensions of the deep pan 200 are identical or similar to the dimensions of the shallow and 100, except that in the deep pan 200 the height of sidewalls above the bottom wall can be between 1.5 inches and 4.0 inches. Because the features and dimensions of the deep pan 200 are similar or identical to those of the shallow pan 100, the deep and the shallow end can be used together, for example, to form an oven by coupling nodes and divots on the deep pan to nubs and divots on the shallow pan.

In addition, the deep pan 200 can be used in combination with the shallow pan to form an oven when both pans 100, 200 are inverted or when both pans are upright—in other words, when the open side of each pan is oriented in the same direction with respect to the bottom wall of the pan.

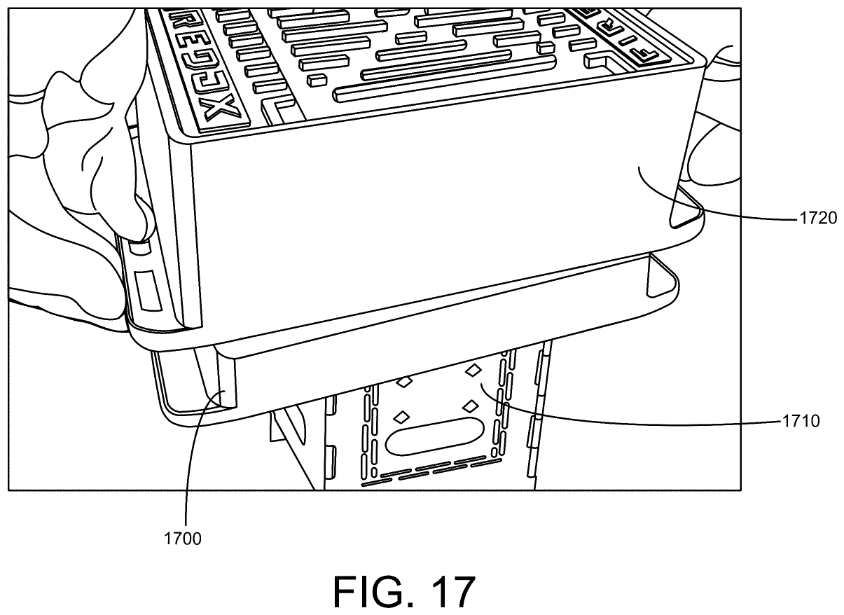

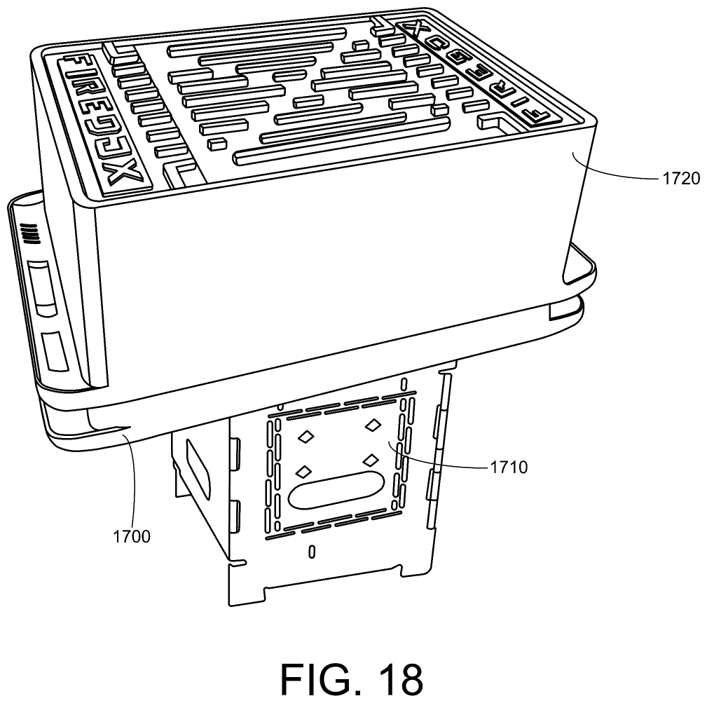

FIG. 17 is a photograph of an example inverted shallow multifunction pan 1700 resting on, and coupled to, a top of a portable stove 1710. Additionally, an inverted deep multifunction pan 1720 is held just above the inverted shallow multifunction pan 1700 by a user. FIG. 18 is a photograph of the example inverted shallow multifunction pan 1700 resting on, and coupled to, a top of a portable stove 1710, with the inverted deep multifunction pan 1720 resting on, and coupled to, the inverted shallow multifunction pan 1700. As shown in FIGS. 17 and 18, because the features and dimensions (except for the depth) of the deep pan 1720 are similar or identical to those of the shallow pan 1700, the inside surfaces of the top portions of sidewalls of the deep pan 1720 (i.e., portions of the sidewalls that are distal from the bottom wall of the deep pan) can fit onto outside surfaces of the bottom portions of sidewalls of the shallow pan 1700 (i.e., portions of the sidewalls that are proximate to the bottom wall of the shallow pan). When so arranged, because the depth of the deep pan 1720 (i.e., the height of the sidewalls above the bottom wall) is greater than the depth of the shallow pan 1700, an enclosure can be formed by the sidewalls of the deep pan 1720, the bottom wall of the deep pan 1720, and the bottom wall of the shallow pan 1700. This enclosure can be used as an oven when the heat is applied to the outside surfaces of the enclosure.

Although the shallow pan 1700 and the deep pan 1720 are shown in inverted orientations in FIGS. 17 and 18 with respect to the portable stove 1710, such that the bottom of the enclosure formed by the coupled pans 1700, 1720 includes the raised ribs 120 of the outer surface of the bottom wall of the shallow pan 1700, the shallow pan 1700 and the deep pan 1720 also can be oriented upright with respect to the portable stove, with the deep pan coupled to the stove and the shallow pan resting on, and coupled to, the deep pan. In such a configuration and orientation, the enclosure formed by the coupled pans 1700, 1720 includes the inner surface of the bottom wall of the deep pan 1720, where the inner surface does not include raised ribs 120.

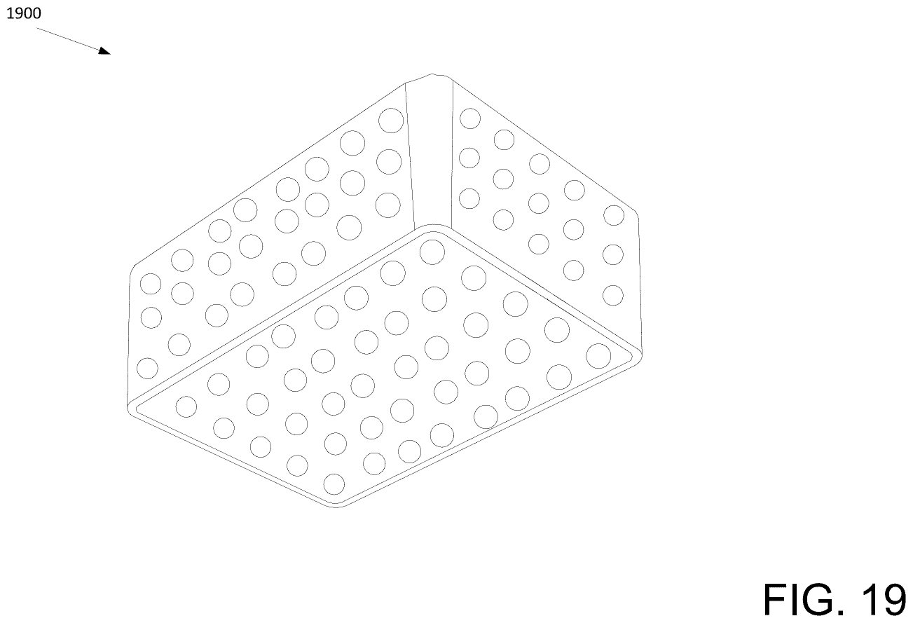

FIG. 19 is a schematic bottom perspective view of a basket 1900 that can be used with the deep pan 200 or the shallow pan 100. In some implementations, the basket 1900 can be a five-sided cooking container having dimensions that are complementary to the interior dimensions of the cooking container formed by the bottom wall and the sidewalls of the deep pan 200, so that the basket 1900 can be placed into the cooking container formed by the bottom wall and sidewalls of the deep pan 200. In some implementations, the basket 1900 can be formed of five sheets of metal that are welded together to form the basket. The sheets of metal can include patterns of openings that permit liquid and solid material having characteristic sizes smaller than the size of the openings to pass out of the basket 1900. Because of this, the basket 1900, in sotranme implementations, can be used as a frying basket to hold food while it is being cooked in liquid (e.g., oil) that is heated within the cooking container of the deep pan 200, and then the basket can be lifted out of the deep pan with the cooked food contained within the basket, while the cooking liquid flows out of the basket and remains in the deep pan 200.

Additionally, the basket 1900 can be used as a kind of a roasting pan while cooking food within the deep pan 200. For example, the basket 1900 can be placed within the deep pan 200, but with the bottom of the basket not directly touching the bottom wall of the deep pan. For example, the bottom of the basket 1900 can be spaced apart from the bottom wall of the deep pan 200 by one or more metal spacers or rocks, and food can be placed within the basket to be roasted by heat from the deep pan 200. Additionally, while the basket 1900 is positioned within the deep pan 200, an inverted deep pan 200 or shallow pan 100 can be coupled to the deep pan 200 by way of the nubs and divots on the flanges of the pans to form an oven in which the food is roasted within the basket 1900.

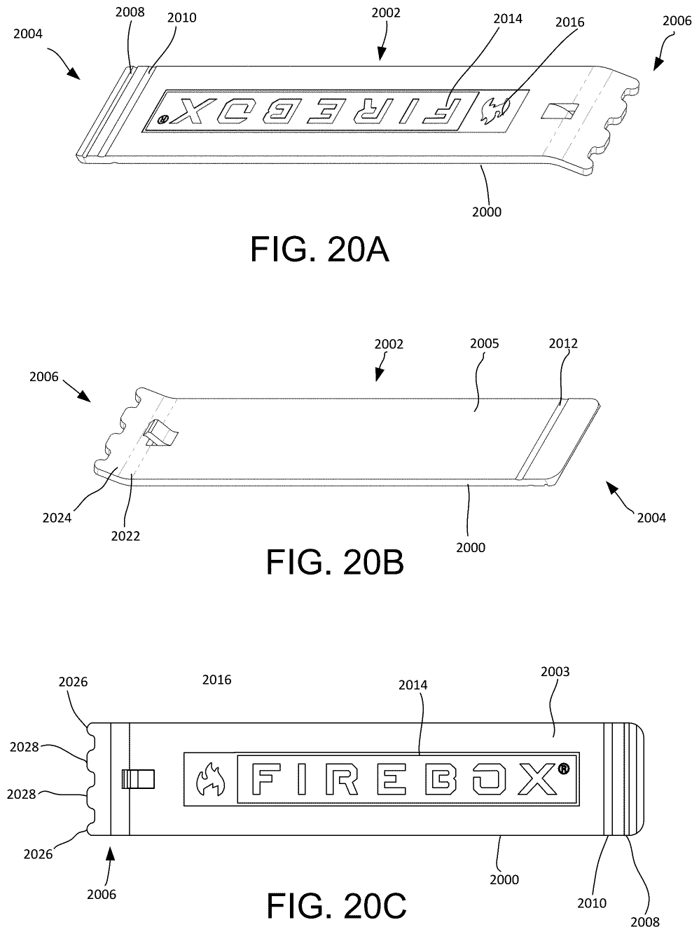

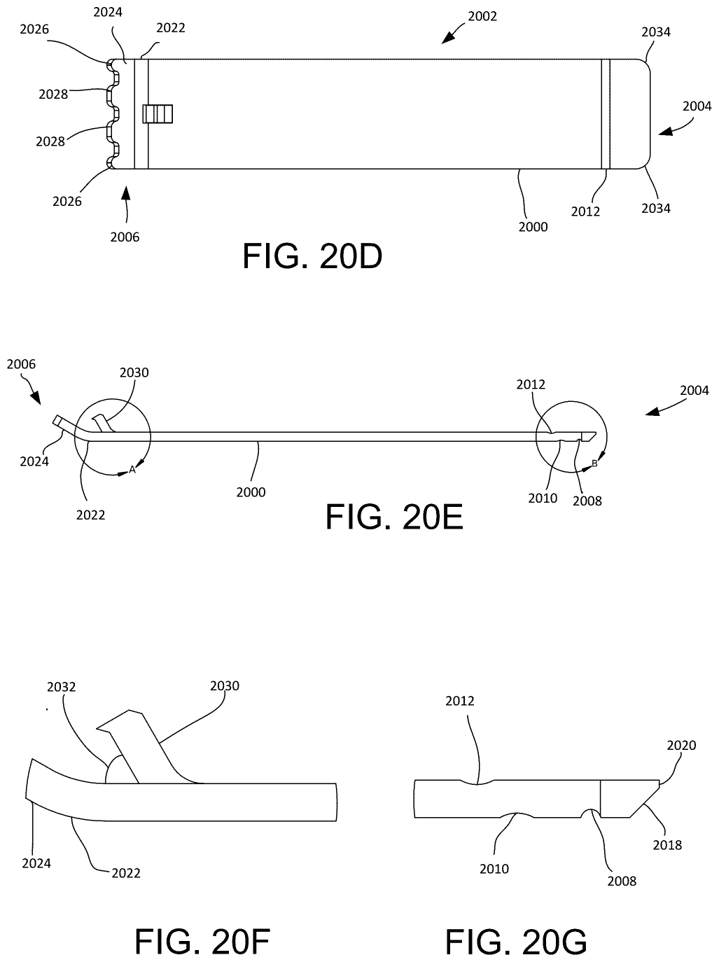

In some implementations, one or more handles can be provided, which can be coupled to the pans 100, 200 to move the pans, for example, while the pans are hot. FIG. 20A is a perspective view from a top side of an example handle 2000 according to an implementation. FIG. 20B is a perspective view from a bottom side of the example handle 2000. FIG. 20C is a top view of the example handle 2000. FIG. 20D is a bottom view of the example handle. FIG. 20E is a side view of the example handle. FIG. 20F is an enlarged view of a first portion of the example handle 2000 shown in the circle “A” of FIG. 20E. FIG. 20G is an enlarged view of a second portion of the example handle 2000 shown in the circle “B” of FIG. 20E.

The handle 2000 can have a generally rectangular shape with a middle section 2002, a first end 2004, and a second end 2006 and can be made of a metal material, for example, aluminum, steel, or cast-iron. The generally-rectangular handle 2000 can include additional features that can be decorative and/or functional. For example, a top side 2003 of the handle can include one or more letters or words 2014 and one or more logos 2016, which may for example, identify a manufacturer of the handle.

The first end 2004 can include one or more grooves or notches in the top side 2003 and/or bottom side 2005 of the handle, which extend transversely across the shorter dimension of the rectangular shape and which can be used to couple the handle to pans 100, 200. For example, on a top side 2003 of the handle, the first end 2004 can include a first transverse groove 2008 and a second transverse groove 2010 that is parallel to the first transverse groove 2008 and that is located distal to the outer extent of the first end 2004 as compared to the first transverse groove 2008. On a bottom side 2005 of the handle, the first end 2004 can include a third transverse groove 2012 that is parallel to the first and second transverse grooves 2008, 2010 and that is located between the first and second transverse groove 2008, 2010 along a direction extending along the long axis of the rectangular shape of the handle. As seen in FIG. 20G, the transverse grooves 2008, 2010, 2012 can have characteristic radii of curvature, and the radius of curvature of each groove can be selected to match a radius of curvature of a feature of a pan 100, 200 to which the handle 2000 is coupled.

The first end 2004 can have a generally flat shape and be located in the same plane as the middle section 2002 of the handle 2000. An outer end of the first end 2004 can have curved corners 2034, where the radii of the curved corners match the radii of the fillets 104A, 106A, 108A, 110A at the joints between the sidewalls 104, 106, 108, 110 and bottom wall 102 of the pans 100, 200. Therefore, the corners 2034 of the handle 2000 can be used to scrape the fillets 104A, 106A, 108A, 110A at the joints between the sidewalls 104, 106, 108, 110 and bottom wall 102 of the pans 100, 200 to clean them. Referring to FIG. 20G, an outer extent of the first end 2004 can include a vertical surface 2020 perpendicular to the top and bottom sides 2003, 2005 of the handle 2000, and extending from the bottom side toward the top side by less than 25% of the thickness of the handle. The first end 2004 also can include an angled surface extending from an end of the vertical surface 2020 to the top side 2003 of the handle. The vertical surface 2020 and the angled surface 2018 of the first end 2004 can function as a blunt chisel or scraper to clean surfaces of the pans 100, 200.

The second and 2006 of the handle 2000 can have a straight section 2024 that extends away from the middle section 2002 of the handle, where the straight section 2024 is angled with respect to the plane of the middle section 2002. The angle of the straight section 2024 with respect to the plane of the middle section 2002 can be between 15° and 45°, for example, 30°. The straight section 2024 can be connected to the middle section by a curved section 2022. The straight section 2024 can include one or more protrusions, including one or more edge protrusions or tines 2026 and middle protrusions 2028, at the outer end of the straight section. The protrusions 2026, 2028 can be sized and shaped to fit into gaps between raised ribs 120 of a surface of the pan 100, 200 and to fill (e.g., to take up more than 80% of the space of) the gaps. Spaces between the protrusions 2026, 2028 of the second and 2026 can be sized and shaped to complement the size and shape of the raised ribs. For example, the spaces between the protrusions 2026, 2028 can have lengths, widths, and radii of curvature that are similar to the heights, widths, and radii of curvature of the raised ribs 120. Thus, the protrusions 2026, 2028 of the second end 2006 can be used to scrape and clean the raised ribs and the gaps between the raised ribs.

At an end of the middle section 2002 proximate to the second end 2006, a tab 2030, which can be centrally located on the bottom side 2005 along a transverse dimension of the rectangular shaped handle 2000, can extend away from the bottom side of the middle section at an angle 2032 to the middle section. The angle 2032 of the tab 2030 with respect to the bottom side can be between 15° and 60°, for example, 45°. The tab 2030 can cooperate with one or more features of the pans 100, 200 to couple the handle 2000 to the pans 100, 200.

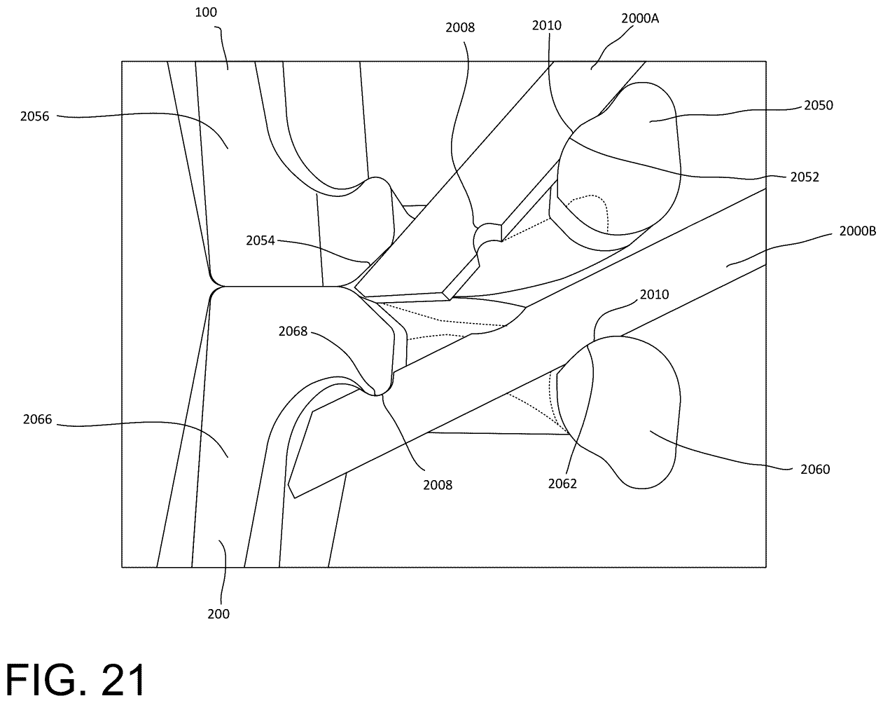

FIG. 21 is a schematic diagram showing how the handle 2000 can couple to a pan 100 that is in a downward facing orientation and how a handle 2000 can couple to a pan 200 that is in an upward facing orientation, so that the handle can be used to lift the pans 100, 200 without the user having to directly touch the pans. The view of the pans 100, 200 in FIG. 21 can be considered as a close-up view of the two pans when they are stacked on top of each other to form an internal cavity, such as is represented in FIG. 16.

The first handle 2000A can be coupled to the pan 100 by inserting the first end of the handle into a space between the handle 2050 of the pan 100 and a sidewall 2056 of the pan. The handle 2000A can be inserted into a position in which the radius of the second transverse groove 2010 of the handle 2000A contacts, and is substantially parallel to, a radius 2052 of the handle 2050 of the pan 100, and so that a flat surface of the bottom side of the first end of the handle touches, and is substantially parallel to, a surface 2054 of the sidewall 2056 of the pan 100. Then, a user can grasp the middle section 2002 and/or the second end 2006 of the handle 2000A and apply a torque and a force to the handle 2000A such that the second transverse groove 2010 is pressed against the radius 2052 of the handle 2050 of the pan 100 and such that the bottom side of the first end of the handle 2000A is pressed against the flat surface 2054 of the sidewall 2056 of the pan 100 to lift the pan 100 by the handle 2000A.

The second handle 2000B can be coupled to the pan 200 by inserting the first end of the handle 2000B into a space between the handle 2060 of the pan 200 and a sidewall 2066 of the pan 200. The handle 2000B can be inserted into a position in which the radius of the third transverse groove 2012 of the handle 2000B contacts, and is substantially parallel to, a radius 2062 of the handle 2060 of the pan 200, and so that the first transverse groove 2008 of the first end of the handle 2000B touches, and is substantially parallel to, a curved surface 2068 of the sidewall 2066 of the pan 600. Then, a user can grasp the middle section 2002 and/or the second end 2006 of the handle 2000B and apply a torque and a force to the handle such that the third transverse groove 2010 is pressed against the radius 2052 of the handle 2060 of the pan 200 and the third transverse groove of the first end of the handle 2000B is pressed against the curved surface 2068 of the sidewall 2066 of the pan 200 to lift the pan 200 by the handle 2000B.

It will be understood that when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly the second and 2006 of the handle 2000 coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An cooking pan comprising:
a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and
four metal sidewalls extending away from the bottom wall and arranged in a substantially rectangular configuration to form a container closed on a first side by the bottom wall and open on second side opposite the bottom wall.

2. The cooking pan of claim 1, wherein the metal bottom wall further includes a raised rim that extends away from the lower surface around a perimeter of the bottom wall.

3. The cooking pan of claim 2, wherein the raised rim includes a cutout section having height above the lower surface that is lower than other portions of the raised rim.

4. The cooking pan of claim 2, wherein the plurality of raised ribs include a plurality of “L”-shaped ribs that extend inward from the raised rim and that are arranged to cooperate with one or more support structures of a portable stove to hold the portable stove in place.

5. The cooking pan of claim 1, wherein the plurality of raised ribs include ribs having straight middle sections of various lengths and rounded end sections.

6. The cooking pan of claim 1, wherein the plurality of raised ribs include ribs that from letters that spell one or more words.

7. The cooking pan of claim 1, wherein the pattern of the plurality of raised ribs includes perpendicular lines devoid of ribs between pluralities of the raised rib, the perpendicular lines devoid of ribs being arranged to cooperate with one or more support structures of a portable stove to hold the portable stove in place.

8. The cooking pan of claim 1, wherein the pattern of the plurality of raised ribs includes a rectangular path along the lower surface that surrounds a plurality of the raised ribs, wherein the path is devoid of any raised ribs and is configured to cooperate with one or more support structures of a portable stove to hold the portable stove in place.

9. The cooking pan of claim 1,
wherein a first sidewall of the four metal sidewalls includes a first flange extending outwardly away from the first sidewall and away from the container,
wherein a second sidewall of the four metal sidewalls, which is opposite to the first sidewall, includes a second flange extending outwardly away from the sidewall and away from the container.

10. The cooking pan of claim 9, wherein each of the first flange and the second flange include a surface having a raised nub that extends away from the surface and an indented divot that extends into the flange, a location and a size of the raised nub being configured for the raised nub, when the cooking pan is in an upright position, to fit into a corresponding indented divot on a flange of another cooking pan, and the location and the size of the indented divot being configured for the indented divot, when the cooking pan is in the upright position, to receive a corresponding indented divot on a flange of another cooking pan, when the other cooking pan is placed on the cooking pan in an inverted position to form an internal cavity that includes the container of the cooking pan and a container of the other cooking pan.

11. An apparatus comprising:
a first cooking pan including:
a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and
four metal sidewalls extending away from the bottom wall and arranged in a substantially rectangular configuration to form a container closed on a first side by the bottom wall and open on second side opposite the bottom wall, the container having a first depth; and
a second cooking pan including:
a metal bottom wall including a substantially smooth and flat inside surface and a substantially flat outside surface, the substantially flat outside surface including a plurality of raised ribs extending away from a lower surface of the bottom wall, the plurality of raised ribs being arranged in a pattern to cooperate with supports of a portable stove to hold the portable stove in place, with the substantially flat outside surface of the bottom wall facing upward and a combustion chamber of the portable stove above the bottom wall; and
four metal sidewalls extending away from the bottom wall and arranged in a substantially rectangular configuration to form a container closed on a first side by the bottom wall and open on second side opposite the bottom wall, the container having a second depth.

12. The apparatus of claim 11, wherein the second depth is different from the first depth.

13. The apparatus of claim 11,
wherein a first sidewall of the four metal sidewalls of the first cooking pan includes a first flange extending outwardly away from the first sidewall and away from the container,
wherein a second sidewall of the four metal sidewalls of the first cooking pan, which is opposite to the first sidewall, includes a second flange extending outwardly away from the sidewall and away from the container,
wherein each of the first flange and the second flange of the first cooking pan and of the second cooking pan include a surface having a raised nub that extends away from the surface and an indented divot that extends into the flange, a location and a size of the raised nubs of the first cooking pan being configured for the raised nubs, when the first cooking pan is in an upright position, to fit into corresponding indented divots second cooking pan, and the location and the size of the indented divots on the flanges of the first cooking pan being configured for the indented divots, when the first cooking pan is in the upright position, to receive corresponding indented divots of the second cooking pan, when the second cooking pan is placed on the first cooking pan in an inverted position to form an internal cavity that includes the container of the first cooking pan and the container of the second cooking pan.

14. The apparatus of claim 11, further comprising a metal basket having four sidewalls and one bottom wall, dimensions the sidewalls and the bottom wall are complementary to interior dimensions of the container of the first cooking pan, such that the basket fits into the container, wherein the four sidewalls and the one bottom wall include patterns of openings that permit liquid and solid material having characteristic sizes smaller than the size of the openings to pass out of the basket.

15. The apparatus of claim 11, wherein the metal bottom of each of the first and second cooking pans includes a raised rim that extends away from the lower surface around a perimeter of the bottom wall of the respective cooking pan, wherein each raised rim includes a cutout section having height above the lower surface that is lower than other portions of the raised rim.

16. The apparatus of claim 11, further comprising a handle, the handle including a flat middle section, a flat first end, the middle section and the first end being in a common first plane, and a second end, the second end including a flat second end section and a curved section connecting the flat second end section to the flat middle section and the flat second end section being in a second plane that is non-parallel to the common first plane, and the flat second end including a plurality of protrusions being shaped and spaced from apart from each other such that each of the protrusions fits between a pair of adjacent raised ribs of the raised ribs.

17. The apparatus of claim 16, wherein the plurality of raised ribs of each of the first and second cooking pans include a plurality of “L”-shaped ribs that extend inward from the raised rim and that are arranged to cooperate with one or more support structures of a portable stove to hold the portable stove in place.

18. The apparatus of claim 11, wherein the plurality of raised ribs of each of the first and second cooking pans include ribs having straight middle sections of various lengths and rounded end sections.

19. The apparatus of claim 11, wherein the pattern of the plurality of raised ribs of each of the first and second cooking pans includes perpendicular lines devoid of ribs between pluralities of the raised rib, the perpendicular lines devoid of ribs being arranged to cooperate with one or more support structures of a portable stove to hold the portable stove in place.

20. The apparatus of claim 11, wherein the pattern of the plurality of raised ribs of each of the first and second cooking pans includes a rectangular path along the lower surface that surrounds a plurality of the raised ribs, wherein the path is devoid of any raised ribs and is configured to cooperate with one or more support structures of a portable stove to hold the portable stove in place.
